(19) United States
(12) Patent Application Publication
(10) Pub. No.: US 2003/0006176 A1
(43) Pub. Date: Jan. 9, 2003

(54) Electric thermos bottle capable of filtering flowing water

(76) Inventor: Kwei Tang Chang, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/986,844

(22) Filed: Nov. 13, 2001

(30) Foreign Application Priority Data
Jul. 9, 2001 (CN) 01231228.2

(51) Int. Cl. B01D 24/38

(52) U.S. Cl. 210/94; 210/184; 210/474; 210/477

(57) ABSTRACT

An electric thermos bottle capable of filtering flowing water comprises a thermos bottle, an internal glass container, a heating pipe, a water pump, a filter, and a water supply pipe. The internal glass container is disposed in the thermos bottle and forms a water-storing space therein. The heating pipe and water pump are disposed at the bottom of the water-storing space, and the filter is disposed at the top thereof. One end of the water supply pipe is connected to the water pump, and the other end thereof forms a reflux mouth and a water outlet respectively disposed above the filter and outside the thermos bottle. The water outlet is connected with a water button. Water in the water-storing space can flow via the water supply pipe to the filter and back to the water-storing space by continual action of the water pump, preventing peculiar smell and filtering out impurities.

### FIELD OF THE INVENTION

The present invention relates to an electric thermos bottle capable of filtering flowing water and, more particularly, to an electric thermos bottle, which filters out impurities in water and prevents peculiar smell by continual and circulative flow of water.

### BACKGROUND OF THE INVENTION

As shown in FIG. 1, a conventional electric thermos bottle comprises a thermos bottle 1a, an internal container 2a, a heating pipe 3a, a water supply pipe 4a, and a water button 5a. The internal container 2a is disposed in the thermos bottle 1a and forms a water-storing space 6a therein. The heating pipe 3a is disposed at the bottom of the water-storing space 6a to heat water in the water-storing space 6a. The water supply pipe 4a is disposed outside the internal container 2a and forms a water inlet 7a and a water outlet 8a at two sides thereof. The water inlet 7a and the water outlet 8a are disposed at the bottom of the water-storing space 6a and outside the thermos bottle 1a, respectively. The water button 5a is disposed at the bottom of the thermos bottle 1a. Water in the water-storing space 6a can flow via the water supply pipe 4a to the water outlet 8a to supply water when the water button 5a is pressed.

Although the above electric thermos bottle can heat water and supply water, water therein is motionless over a long period of time when it is not used to supply water, hence easily generating peculiar smell. Moreover, because impurities in water are not filtered out, drinking this water for a long time will result in deterioration of health.

Accordingly, the above electric thermos bottle has inconvenience and drawbacks in practical use. The present invention aims to resolve the problems in the prior art.

### SUMMARY OF THE INVENTION

The primary object of the present invention is to provide an electric thermos bottle, which can filter out impurities in water and prevent peculiar smell by continual and circulative flow of water, hence enhancing sanitation and safety of drinking water.

To achieve the above object, the prevent invention provides an electric thermos bottle capable of filtering flowing water, which comprises a thermos bottle, an internal glass container, a heating pipe, a water pump, a filter, and a water supply pipe. The internal glass container is disposed in the thermos bottle and forms a water-storing space therein. The heating pipe and the water pump are disposed at the bottom of the water-storing space. The filter is disposed at the top of the water-storing space. One end of the water supply pipe is connected to the water pump, and the other end thereof forms a reflux mouth and a water outlet, which are disposed above the filter and outside the thermos bottle, respectively. The water outlet is connected with a water button. Water in the water-storing space can flow through the water supply pipe and the filter, exude out from the filter, and then flow back to the water-storing space by continual action of the water pump, hence preventing peculiar smell and filtering out impurities.

The various objects and advantages of the present invention will be more readily understood from the following detailed description when read in conjunction with the appended drawing, in which:

### BRIEF DESCRIPTION OF THE DRAWINGS

FIG. 1 is a cross-sectional view of a prior art electric thermos bottle;

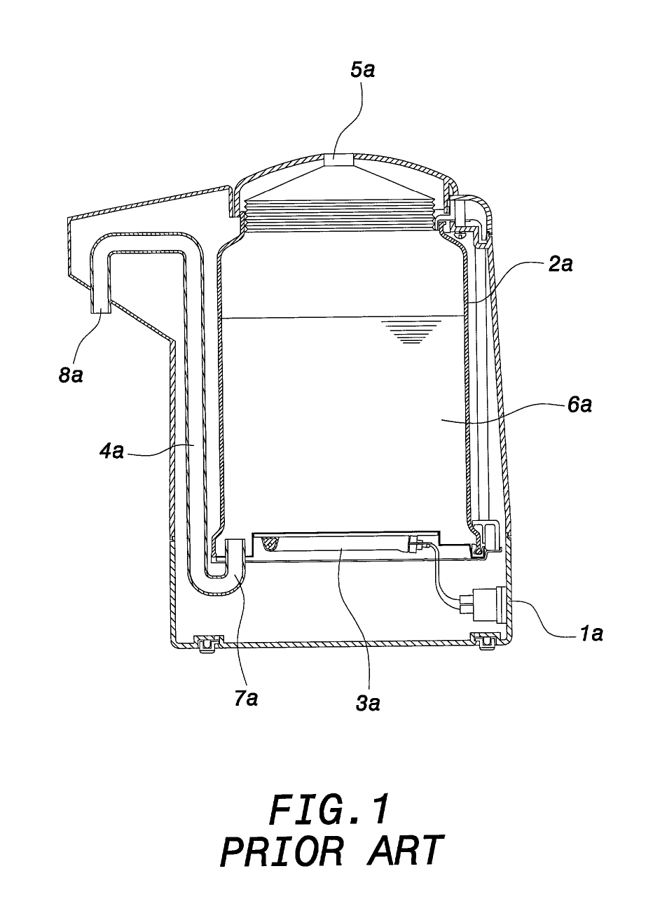

FIG. 2 is a perspective view of the present invention;

FIG. 3 is a cross-sectional view of the present invention;

FIG. 4 is a diagram of a first action of the present invention; and

FIG. 5 is a diagram of a second action of the present invention.

### DETAILED DESCRIPTION OF THE PREFERRED EMBODIMENTS

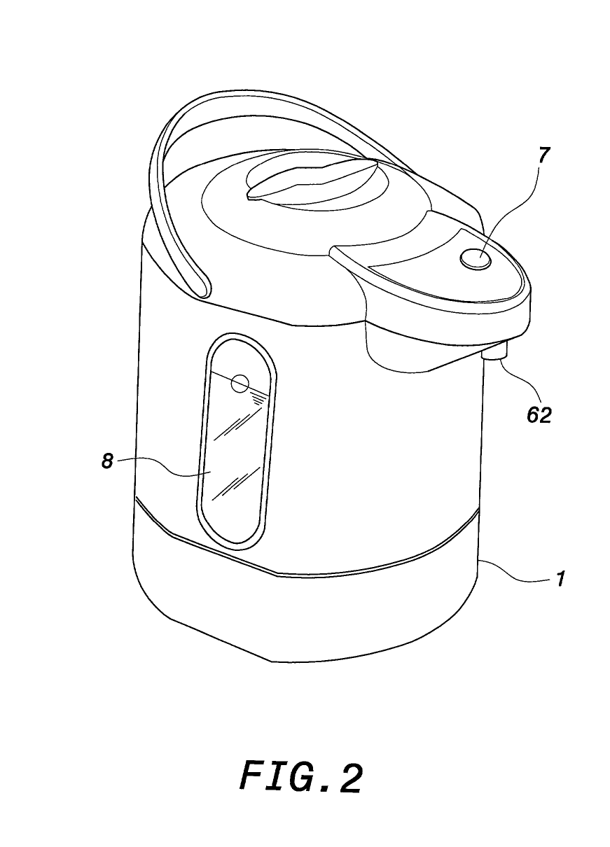

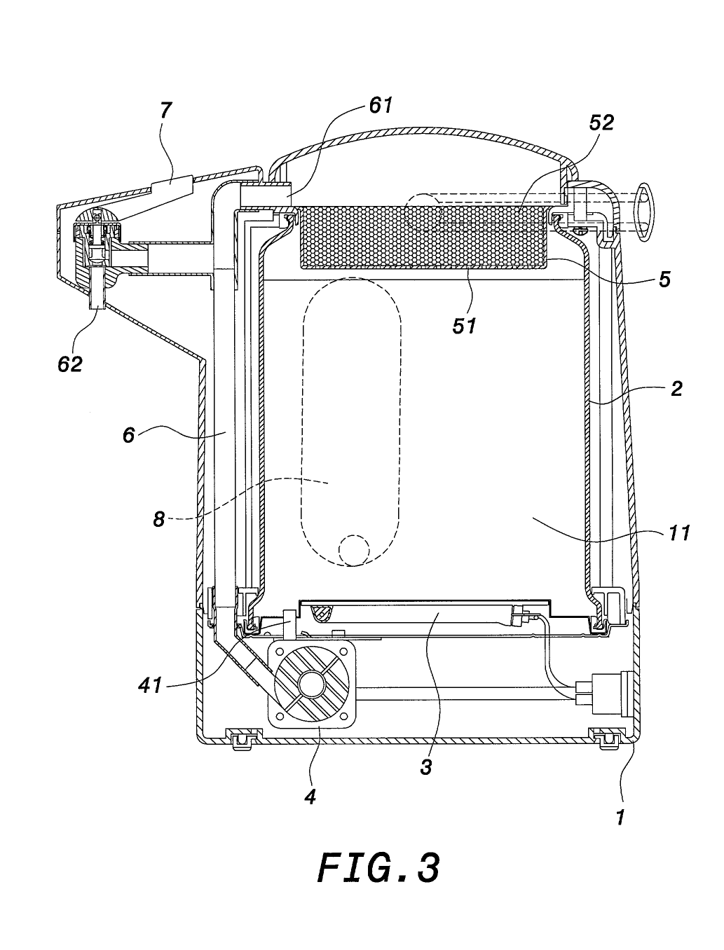

As shown in FIGS. 2 and 3, the present invention provides an electric thermos bottle capable of filtering flowing water, which comprises a thermos bottle 1, an internal glass container 2, a heating pipe 3, a water pump 4, a filter 5, and a water supply pipe 6. The internal glass container 2 is disposed in the thermos bottle 1 and forms a water-storing space 11 therein. The heating pipe 3 and the water pump 4 are disposed at the bottom of the water-storing space 11. The heating pipe is used to heat water in the water-storing space 11. The water pump 4 has a water inlet 41. The filter 5 is disposed at the top of the water-storing space 11. A plurality of holes 51 are disposed at the bottom of the filter 5. Filtering material 52 is filled in the filter 5. The filtering material 52 can be composed of wheat stone and active carbon. The water supply pipe 6 is disposed outside the internal glass container 2. One end of the water supply pipe 6 is connected to the water pump 4, and the other end thereof forms a reflux mouth 61 and a water outlet 62, which are disposed above the filter 5 and outside the thermos bottle 1, respectively. The water outlet 62 is connected with a water button 7. The reflux mouth 61 is higher than the water outlet 62. A transparent window 8 is disposed at the outside of the thermos bottle 1. Variation of water position in the internal glass container 2 can be seen via the transparent window 8.

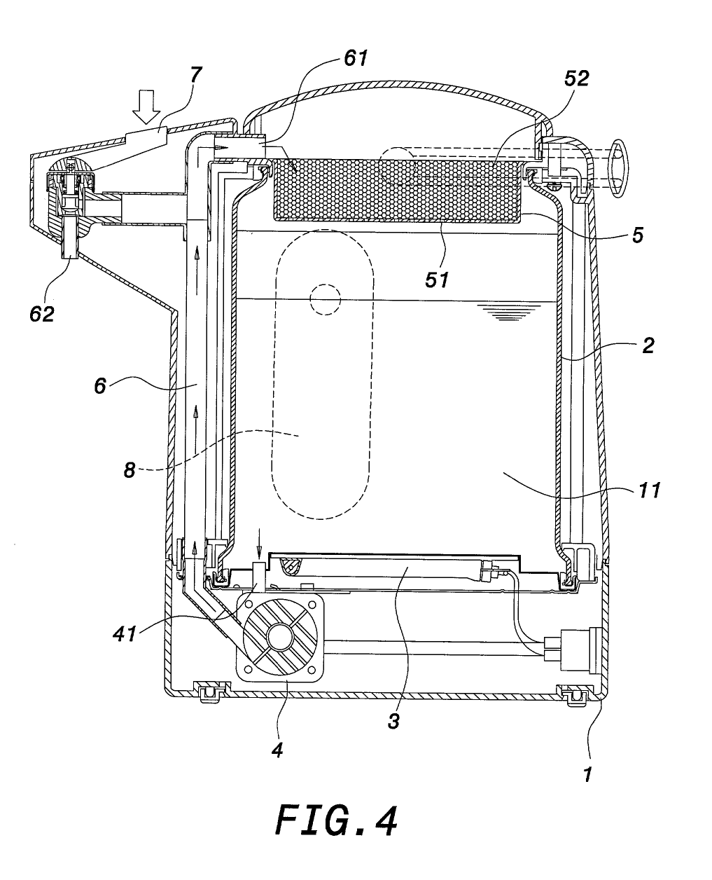

Please refer to FIG. 4. In order to prevent peculiar smell due to long-term placement of water, water in the water-storing space 11 is sucked in from the water inlet 41 and sent to the water supply pipe 6, flows out of the reflux mouth 61, is filtered by the filtering material 52 in the filter 5 to filter out impurities in water, and finally exudes out of the holes 51 of the filter 5 by continual action of the water pump 4. Water in the water-storing space 11 will thus form flowing water by continual repetition of the above steps, hence preventing peculiar smell and filtering out impurities. Therefore, sanitation and safety of drinking water can be assured.

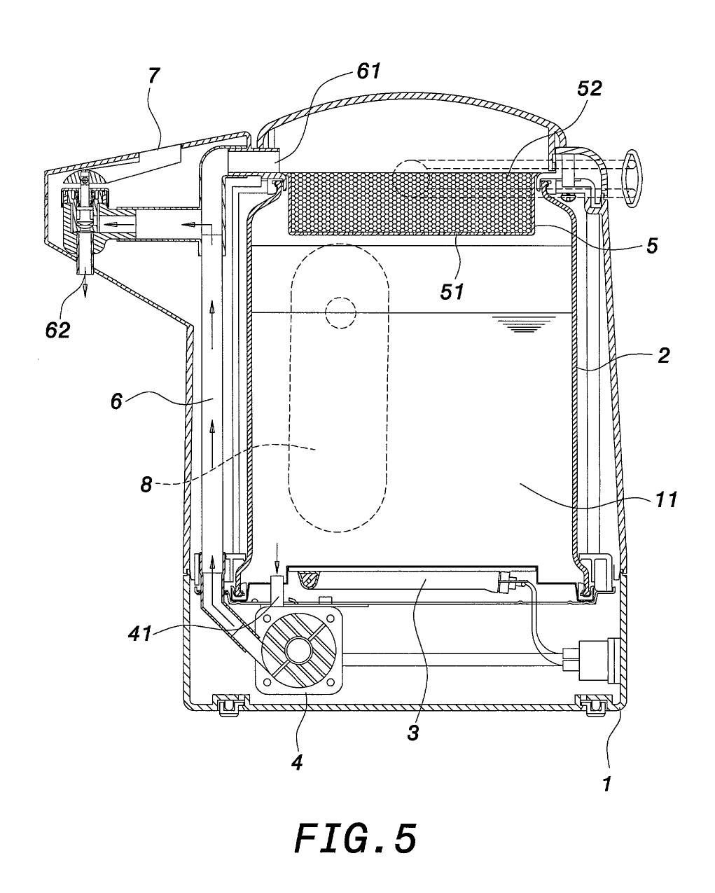

Please refer to FIG. 5. When a user wants to get water, he presses the water button 7 to let the water pump 4 suck in water in the water-storing space 11 via the water inlet 41. The water is then sent out to the water supply pipe 6 to flow out of the water outlet 62. Because the water outlet 62 is lower than the reflux mouth 61, the user can get water via the water outlet 62 when he presses the water button 7.

The electric thermos bottle capable of filtering flowing water of the present invention has the following characteristics.

1. Peculiar smell can be prevented.

2. Impurities in water can be filtered out.

3. Variation of water position can be seen via the transparent window.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An electric thermos bottle capable of filtering flowing water, comprising:
a thermos bottle;
an internal glass container disposed in said thermos bottle and forming a water-storing space therein;
a filter disposed at a top of said water-storing space;
a heating pipe disposed in a bottom of said water-storing space;
a water pump disposed at the bottom of said water-storing space; and
a water supply pipe, one end thereof being connected to said water pump, and the other end thereof forming a reflux mouth and a water outlet, said reflux mouth being disposed above said filter, said water outlet being disposed outside said thermos bottle, said water outlet being connected with a water button;
whereby water in said water-storing space can flow through said water supply pipe, flow out of said reflux mouth, and be filtered by said filter by continual action of said water pump, or water in said water-storing space can flow through said water supply pipe and out of said water outlet when said water button is pressed.

2. The electric thermos bottle as claimed in claim 1, wherein a transparent window is disposed at an outside of said thermos bottle.

3. The electric thermos bottle as claimed in claim 1, wherein said reflux mouth is higher than said water outlet.

4. The electric thermos bottle as claimed in claim 1, wherein a plurality of holes are disposed at a bottom of said filter.
